(19) United States
(12) Patent Application Publication
(10) Pub. No.: US 2003/0169162 A1
(43) Pub. Date: Sep. 11, 2003

(54) Interior vehicle alert system

(76) Inventor: Charles T. Hyman, Garland, TX (US)

Correspondence Address: Michael L. Diaz, Michael L. Diaz, P.C., Suite 200, 555 Republic Drive, Plano, TX, 75074, US

(21) Appl. No.: 10/091,676

(22) Filed: Mar. 5, 2002

(51) Int. Cl. B60Q 1/00

(52) U.S. Cl. 340/438; 340/584

(57) ABSTRACT

A system providing conditioning air to an interior of a vehicle when a dangerous temperature is encountered. The system includes a sensing device for sensing the temperature of the interior of the vehicle. The sensing device is also used for determining if an occupant is present within the vehicle's interior. The system includes an environmental unit which provides conditioned cooled or heated air to the interior of the vehicle. A microprocessor is used to determine when a temperature threshold is exceeded and an occupant is present to initiate the cooling or heating of the air within the interior of the vehicle. The air is cooled or heated to alleviate the dangerous temperature. Additionally, the system provides a visual and audio alert to nearby people to alert them of the dangerous condition.

### BACKGROUND OF THE INVENTION

1. Technical Field of the Invention

This invention relates to vehicle alert systems, and more particularly, to an alert system providing a warning of a vehicle's excessive temperature and a heating and cooling system for changing the excessive temperature within the vehicle's interior.

2. Description of Related Art

Each year, numerous children are left alone within the interior of a vehicle. For several reasons, the situation where a child is left behind in a vehicle can be extremely dangerous. Besides the obvious concern of a child misbehaving within the interior of an unsupervised vehicle, the child may be subjected to excessive temperatures. Unfortunately, in several cases, the child has tragically died due to exposure to such excessive temperatures. For example, during the height of summer, the temperature becomes unbearably hot within a vehicle's interior. When a child is left within the interior of the vehicle, the child must contend with the high temperatures. Oftentimes, adults believe that the temperature of the interior does not change in a short period of time. However, studies have shown that dangerous temperatures may develop in as short of a time span as one or two minutes. Due to this common misconception, each year, several children die due such excessive heat exposure. The same risks and results are also seen with extremely cold temperatures. Although a vehicle is normally heated during colder weather, when the vehicle's engine is turned off, temperatures may also drop to a dangerous condition.

Although children are particularly susceptible to being subjected to excessive temperatures, pets left within the vehicle's interior fare no better. Like small children, pets are unable to communicate their desires. Again, many pets left behind in an interior of a vehicle have also died.

Although there are no known prior art teachings of a device such as that disclosed herein, prior art references that discuss subject matter that bears some relation to matters discussed herein are U.S. Pat. No. 3,947,815 to Muncheryan ('815), U.S. Pat. No. 5,793,291 to Thorton ('291), and U.S. Pat. No. 5,966,070 to Thorton ('070).

'815 discloses an emergency alarm system for automobiles for signaling nearby people that the driver of the occupant of the car needs immediate help due to sudden attack of illness, heart trouble, stroke, or intrusion by burglars or other criminals. The system includes an alert and light-flashing device actuated by manually operating switches located at various readily-accessible parts of the car, or triggered automatically from an alarm-triggering device carried on the shirt pocket of the car driver or occupant. However, '815 does not teach or suggest an alert system triggered by excessive temperatures or a system which actively cools or heats the interior of a vehicle when excessive temperatures are encountered.

'291 discloses an alarm system for detecting the presence of a person locked in a parked automobile. The alarm system includes a motion detector and a temperature detecting element. The motion detector transmits a low signal once it detects motion within the interior of the automobile. The temperature detecting element transmits a low signal if the temperature in the automobile exceeds a pre-determined extreme temperature. Upon receipt of low signals from both the temperature detecting element and the motion detector, an alarm signal is transmitted. However, '291 does not teach or suggest actively changing the temperature within the interior of a vehicle to a more habitable temperature level. '291 merely provides a warning when an excessive temperature is encountered.

'070 also discloses an alarm system for detecting the presence of a child locked within a parked automobile during extreme temperatures. The alarm system includes a temperature detecting element and a child detecting element electrically coupled to the system. The temperature detecting element transmits an extreme temperature signal if the temperature within the automobile exceeds a pre-selected maximum temperature. The child detecting element transmits a child detection signal to the system when it detects a child within the automobile. Upon receipt of both the child detection signal and the extreme temperature signal, the system transmits an alarm signal. Again, '070 does not teach or suggest a system which provides conditioned air to the automobile's interior to alleviate the extreme temperature.

Review of the foregoing references reveals no disclosure or suggestion of a system which provides both an alert system when an occupant is located within an interior of a vehicle with an excessive temperature and a cooling or heating system to change the excessive temperature and thus eliminate or mitigate the risks to the occupants of the vehicle's interior. It is an object of the present invention to provide such a system.

### SUMMARY OF THE INVENTION

In one aspect, the present invention is an environmental system for a vehicle. The system includes a vehicle having an interior occupied by an occupant. In addition, a sensing device is used for sensing the temperature of the interior of the vehicle. The sensing device also is used for detecting a presence of the occupant within the interior. The system conditions air within the interior of the vehicle. A microprocessor activates the system for conditioning the air when the sensing device senses the occupant is located within the interior of the vehicle and when a predetermined temperature threshold is sensed by the sensing device. The conditioned air alleviates the temperature of the interior.

In another aspect, the present invention is an environmental system providing warning of dangerous temperatures within an interior of the vehicle. The system includes a vehicle having an interior occupied by an occupant. A sensing device is used for sensing a temperature of the interior of the vehicle. The sensing device also includes a detector for detecting a presence of the occupant within the interior. In addition, the system includes an environmental unit located on the vehicle for conditioning air within the interior of the vehicle. The system also includes an alert system which provides an alert indicating that the temperature threshold has been exceeded and the occupant is present within the interior of the vehicle. The system utilizes a microprocessor for activating the environmental unit and alert system when the sensing device senses the occupant within the interior of the vehicle and when a predetermined temperature threshold is exceeded. The conditioned air alleviates the temperature of the interior and the alert system provides the alert to any nearby persons.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a top view of an alert system in the preferred embodiment of the present invention; and

FIG. 2 is a side view of the environmental unit showing a partial interior portion in the preferred embodiment of the present invention.

### DETAILED DESCRIPTION OF EMBODIMENTS

A system for alerting individuals of the presence of a person within a vehicle having an excessive temperature as well as a heating and cooling system for automatically changing the interior's temperature is disclosed.

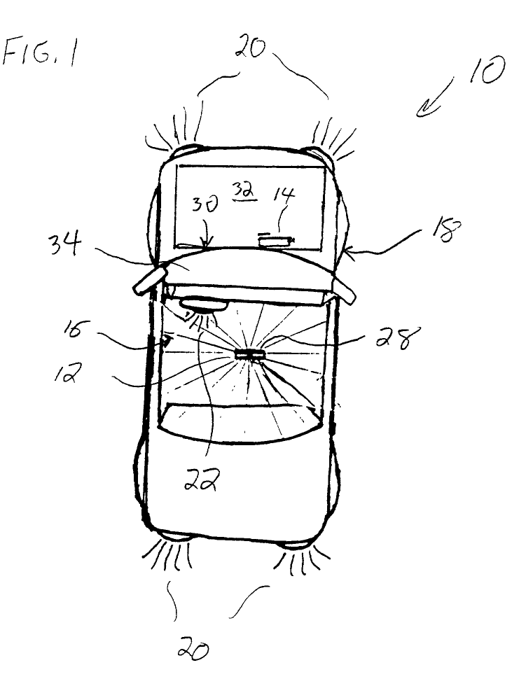

FIG. 1 is a top view of an alert system 10 in the preferred embodiment of the present invention. The system includes a sensing device 12 and an auxiliary environmental unit 14 mounted within an interior 16 of an automobile 18. The automobile includes a plurality of flashable lights 20, and a horn 22. The flashing lights may be conventional lights commonly mounted on the exterior of most vehicles. In addition, the horn may be any device which produces an audible warning. In the preferred embodiment of the present invention, the horn is a conventional horn. In an alternate embodiment, the system may incorporate the use of a voice device, which may be incorporated within or separately from the horn 22. The voice device may be used to provide verbal alerts to nearby people.

In the preferred embodiment of the present invention, the sensing device 12 provides a dual sensing function. First, the sensing device monitors the temperature within the interior of the automobile 18. Any temperature sensing device may be used to determine the temperature of the interior of the automobile. In addition, the sensing device detects the presence of an occupant within the interior of the automobile. In the preferred embodiment of the present invention, the sensing device is a conventional motion detector sensing movement within the vehicle. Such a motion detector is well known in the art of home alarm systems. In other embodiments, the sensing device may detect a presence in the automobile by sensing for body temperatures or sounds produced within the interior of the automobile. As depicted within FIG. 1, the sensing device emits light beams, such as infrared beams, from a center portion of the automobile. Preferably, the sensing device is mounted directly or adjacently the dome light of the automobile. However, the sensing device may be located in any location providing a position to detect a presence within the interior of the automobile. For example, the sensing device may be a plurality of devices positioned on a portion of each door. When an occupant crosses the light beams, the sensing device detects motion. The sensing device may be two separate sensing devices (to monitor temperature and detect the presence of an occupant) or one integrated device performing both functions.

The environmental unit 14 provides a source of additional heating or cooling to correct an unbearable temperature condition. The environmental unit may be located anywhere on the automobile 18, such as against a firewall 30 within an engine compartment 32 of the automobile (as illustrated in FIG. 1). In an alternate embodiment, the environmental unit may be located within the interior 16 of the automobile, under a dashboard 34. In such a configuration, a flexible tubing common within the environmental system of most vehicles, may be utilized to pump air directly into the ventilation system of the automobile. Since the coolant reservoir of the automobile may be located closer to the environmental unit in this alternate configuration, the entire system cost is reduced.

The environmental unit is actuated by the fulfillment of two conditions. First, the temperature within the interior sensed by the sensing device must exceed a designated threshold, either uncomfortably hot or cold. Secondly, the sensing device must sense the presence of an occupant within the automobile. Once these two conditions are met, the environmental unit is actuated to provide heated or cooled air to the interior of the automobile. In order to determine if the two conditions are fulfilled, the sensing device may include a microprocessor 28 residing within the sensing unit. However, the microprocessor may be located anywhere within the automobile. In addition, the microprocessor may be incorporated within the automobile's command computer, found in many newer model vehicles.

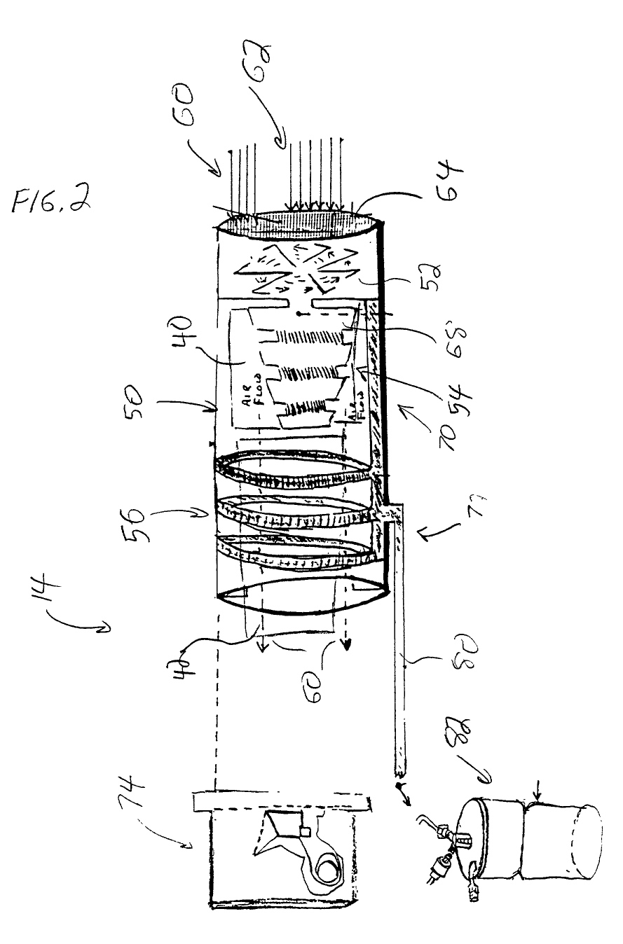

FIG. 2 is a side view of the environmental unit 14 showing a partial interior portion in the preferred embodiment of the present invention. As discussed above, the environmental unit provides auxiliary heating or cooling of the interior of the automobile 18. The environmental unit includes an outer casing 50 housing a plurality of fan blades 52, a plurality of heating coils 54, and tubing 56. The outer casing may be constructed of any rigid material, such as metal or a type 7 plastic. Additionally, the plurality of heating coils may include an insulation 40 providing insulation between the heating coils, which may generate intense heat, and the tubing. This additional insulation provides protection for the tubing against the heat generated by the heating coils. In another alternate embodiment of the present invention, an insulation 42 may be positioned through the center of the environment unit, abeam the tubing. In such a configuration, the air flow generated by the heating coils is directed through a void running through the tubing. The insulation is positioned in such a manner as to protect the tubing from contending with a majority of the heated air flow. Both insulations 40 and 42 may be constructed out any material providing temperature insulation, such as type 7 plastic.

The fan blades are arranged circumferentially around a shaft (not shown). The fan blades may be constructed out of any material which is rigid, such as plastic or metal. In the preferred embodiment of the present invention, it has been found that five blades provide sufficient assistance in driving the air flow through the environmental unit. However, any number of blades may be utilized. The shaft is rotationally driven by an auxiliary motor 68. The motor 68 receive power from the automobile battery or an auxiliary battery. An air flow 60 travels through an inlet area 62. A mesh covering 64 is positioned over the inlet area to prevent debris from entering through the inlet and damaging the plurality of blades. The blades are rotated about the shaft to agitate the air and provide circulation of the air flow through the environmental unit.

The air flow then enters a heating section 70, where the plurality of heating coils resides. Preferably, the environmental unit employs three to five conventional heating coils. Next, the air flow travels to a middle cooling section 72, where the tubing resides. The tubing is hollow and capable of holding coolant. The automobile coolant system is tapped by an extension tubing 80 running from the tubing 56 to an existing automobile coolant reservoir 82. The air flow may then be passed through an existing conventional blower motor 84 found in most automobiles. The blower motor 74 provides circulation of the conditioned air flow into the interior 16 of the automobile 18.

The heating section 70 provides the function of heating the air flow to a warmer temperature. The conditioned hotter air is piped into the interior 16 of the automobile 18 through the conventional ventilation system of the automobile.

In a similar manner, the cooling section 72 provides the function of providing conditioned cooled air, through the ventilation system of the automobile.

For both the cooling and heating functions of the environmental unit 14, the air flow 60 may be optionally directed through the automobile blower motor 74 conventionally available in most automobiles. The existing blower motor typically provides air flow from an air conditioning or heating unit normally installed in the automobile.

Although the horn 22 may be used to warn people of occupants within the vehicle, a sound emitting device may be used to provide a verbal warning. For example, when the temperature threshold is exceeded and an occupant is detected within the automobile by the sensing device 12, an audible warn may include “Help! Someone is in the car!” This audible warning may continue until the automobile is unlocked and the sensing device is turned off manually.

With reference to FIGS. 1 and 2, the alert system 10 will now be explained. The alert system may be automatically or manually activated by an operator of the automobile. Automatic activation may be initiated by the removal of the key from the ignition and the locking of the automobile doors. In other embodiments, other events may trigger the activation of the system, such as pressure sensors located within the driver's seat. In the manual mode, the alert system may include a switch (not shown) to manually turn on and off the system. Additionally, the type of protection provided may also be selected. For example, protection against excessive heat may suggest activation of the cooling portion of the system. Likewise, if the threat is that the temperature may become too cold, the heating portion of the system may be used.

Once the alert system 10 is activated, the sensing device 12 commences monitoring for two conditions. First, the sensing device sensing the interior 16's temperature. If the temperature reaches a designated threshold, the microprocessor 28 determines that the first condition is met. For example, the threshold temperature may be set to 100 degrees Fahrenheit. If the interior of the automobile exceeds 100 degrees, the first condition is met. In another example, the temperature threshold may be set at 50 degrees Fahrenheit. If the temperature drops below 50 degrees, the sensing device determines that the first condition has been met. Either sequentially, or simultaneously, the sensing device monitors for the presence of occupants within the interior of the automobile. If the presence is detected by the sensing device, the second condition is fulfilled. In the preferred embodiment of the present invention, the sensing device is a motion detector which detects movement within the automobile.

Once the sensing device 12 determines that the two conditions have been fulfilled, the sensing device activates the environmental unit 14. If the temperature has exceeded the high threshold, i.e., the interior is too hot, the microprocessor 28 activates the cooling function of the environmental unit. The air flow 60 passes through the inlet area 62. The plurality of fan blades 52 provide additional assistance in moving the air through the environmental unit. As the air passes through the cooling section 72, the tubing 56 provides a cooling function. The tubing is filled with coolant provided through the extension tubing 80 from the conventional automobile coolant reservoir 82. The air flow continues through the environmental unit and is drawn out into the interior of the vehicle by the existing blower motor 74. Thus, cooling air is automatically provided to the interior of the automobile to alleviate the dangerous condition.

If the sensing device 12 determines that the temperature has dropped below the low threshold, i.e., the temperature of the interior is too cold, and that an occupant is present within the automobile, the microprocessor activates the heating function of the environmental unit 14. The air flow 60 is drawn through the inlet area 62 by the plurality of blades 52. The air flow passes through the heating section 70 and is heated by the heating coils 54. The conditioned air flow 60 then continues through the environmental unit and drawn out to the interior of the automobile by the conventional blower motor 74. Thus, when the temperature becomes dangerously cold within the automobile and an occupant is detected, the environmental unit provides heated air to the interior.

In addition to alleviating the dangerous temperature within the automobile, the system 10 simultaneously provides an alert function to inform nearby individuals of the dangerous conditions within the interior of the automobile. When the two conditions described above are fulfilled, the microprocessor 28 commands that alert signals be transmitted. The alert signals may include the flashing of the automobile lights 20, the sounding of the horn 22, or the emitting of an audible signal, such as “Help! Someone is in the car!” Also, additionally lighting or visual signals may be used to provide additional warning to people. All or select types of signals may be used to alert passing people.

The alert system 10 continues to condition the air to the interior of the automobile and provide an alert signal until one of the conditions is no longer fulfilled (e.g., the interior temperature no longer exceeds the threshold temperature), the system is manually turned off, or the automatic feature is disabled (e.g., unlocking the automobile or placing the key in the ignition).

The alert system 10 may be utilized with any vehicle holding passengers. In addition, although the alert system is depicted as an integrated heating and cooling system, the alert system may incorporate just one portion of the environmental unit. For example, in hotter climates, the heating section may not be necessary.

The alert system 10 provides many advantages. First, the system is able to determine when a dangerous temperature condition is encountered within a vehicle's interior. Once determining that an occupant is present within the vehicle, the alert system provides an alert to nearby persons of the dangerous condition. By providing the alert, individuals may take actions to prevent any harm to be done to the occupants. It also provides a signal to the driver, who may return to the vehicle and remove the occupant from the dangerous situation. Additionally, the alert system provides alleviation of the temperature by conditioning the air, either through the cooling or heating of the air. Through the environmental unit, the system can change the dangerous condition, thereby preventing harm to the occupant. Therefore, the alert system can be used to actively save lives.

It is thus believed that the operation and construction of the present invention will be apparent from the foregoing description. While the system shown and described has been characterized as being preferred, it will be readily apparent that various changes and modifications could be made therein without departing from the scope of the invention as defined in the following claims.

What is claimed is:

1. An environmental system for a vehicle, the system comprising:
a vehicle having an interior occupied by an occupant;
a sensing device for sensing a temperature of the interior of said vehicle, said sensing device having means for detecting a presence of the occupant within the interior;
means for conditioning air within the interior of said vehicle; and
a microprocessor for activating said means for conditioning air when said sensing device senses the occupant within the interior of said vehicle and when a predetermined temperature threshold is sensed by said sensing device;
whereby the conditioned air alleviates the temperature of the interior.

2. The environmental system of claim 1 wherein said means for conditioning air is an environmental unit located within the vehicle.

3. The environmental system of claim 2 wherein the environmental unit is located on a firewall of the vehicle.

4. The environmental system of claim 2 wherein the environmental system is a cooling system providing cooled air flow to the interior of said vehicle when a high temperature threshold is exceeded, said cooled air flow being pumped into the interior.

5. The environmental system of claim 4 wherein the cooling system includes a tubing having coolant tapped from a coolant reservoir located within said vehicle.

6. The environmental system of claim 2 wherein the environmental unit includes a motor to drive air through the environmental system for conditioning.

7. The environmental system of claim 2 wherein the environmental unit includes a heating system providing a heated air flow to the interior of said vehicle when a low temperature threshold is exceeded, said heated air flow being pumped into the interior.

8. The environmental system of claim 7 wherein said heating system includes a plurality of heating coils to heat the air flow.

9. The environmental system of claim 1 further comprising an alert system which provides an alert indicating that the temperature threshold has been exceeded and an occupant is present within the interior of said vehicle.

10. The environmental system of claim 9 wherein the alert includes a visual indicator that the temperature threshold has been exceeded and an occupant is present within the interior of said vehicle.

11. The environmental system of claim 10 wherein said visual indicator is lights affixed to an exterior of said vehicle.

12. The environmental system of claim 9 wherein the alert includes an audible indicator that the temperature threshold has been exceeded and an occupant is present within the interior of said vehicle.

13. The environmental system of claim 12 wherein the audible indicator is a horn attached to said vehicle.

14. The environmental system of claim 12 wherein the audible indicator provides a verbal message.

15. The environmental system of claim 1 wherein said sensing device is a motion detector detecting motion by the occupant within the interior of said vehicle.

16. An environmental system providing warning of dangerous temperatures within an interior of the vehicle, the system comprising:
a vehicle having an interior occupied by an occupant;
a sensing device for sensing a temperature of the interior of said vehicle, said sensing device having means for detecting a presence of the occupant within the interior;
environmental unit located on the vehicle for conditioning air within the interior of said vehicle;
an alert system which provides an alert indicating that the temperature threshold has been exceeded and the occupant is present within the interior of said vehicle; and
a microprocessor for activating said environmental unit and said alert system when said sensing device senses the occupant within the interior of said vehicle and when a predetermined temperature threshold is exceeded;
whereby the conditioned air alleviates the temperature of the interior and the alert system provides the alert to any nearby persons.

17. The environmental system of claim 16 wherein the environmental system is a cooling system providing cool air flow to the interior of said vehicle when a high temperature threshold is exceeded, said cool air flow being pumped into the interior.

18. The environmental system of claim 16 wherein the environmental unit includes a heating system providing a heated air flow to the interior of said vehicle when a low temperature threshold is exceeded, said heated air flow being pumped into the interior.
